(19) United States
(12) Patent Application Publication
(10) Pub. No.: US 2003/0155216 A1
(43) Pub. Date: Aug. 21, 2003

(54) Keypad assembly for portable radio terminal

(75) Inventors: Sung-Sun Park, Kumi-shi (KR); Jong-Gun Bae, Kumi-shi (KR)

Correspondence Address: Paul J. Farrell, Esq., DILWORTH & BARRESE, 333 Earle Ovington Boulevard, Uniondale, NY, 11553, US

(73) Assignee: SAMSUNG ELECTRONICS CO., LTD., KYUNGKI-DO (KR)

(21) Appl. No.: 10/197,735

(22) Filed: Jul. 18, 2002

(30) Foreign Application Priority Data
Feb. 15, 2002 (KR) P2002-8183

(51) Int. Cl. H01H 9/26

(52) U.S. Cl. 200/5 R

(57) ABSTRACT

The invention relates to a keypad assembly installed in a portable radio terminal. The keypad assembly comprises a number of alpha-numeric keys arranged on the main body or the sub-body; navigation keys installed among the alpha-numeric keys for executing both alpha-numeric and navigation functions; and a function key installed separate from the alpha-numeric and navigation keys for executing mutual switching between the alpha-numeric function alpha-numeric and the navigation function of the navigation keys. The navigation keys double as alpha-numeric keys so as to satisfy various functions of a terminal desired by a user while minimizing the size of the terminal.

### PRIORITY

This application claims priority to an application entitled “Key Pad Assembly for Portable Radiotelephone” filed in the Korean Industrial Property Office on Feb. 15, 2002 and assigned Ser. No. 2002-8183, the contents of which are hereby incorporated by reference.

### BACKGROUND OF THE INVENTION

1. Field of the invention

The present invention relates to a keypad assembly for a portable radio terminal, in particular, which has navigation keys functioning as dial keys in order to downsize the terminal.

2. Description of the Related Art

Lately, as the information communication industry develops, consumers can choose from a number of portable radio terminals having various functions and shapes on the market. Representative examples of the portable radio terminals include a general bar-type terminal, a flip-type terminal having a flip cover, and a folder-type terminal having a sub-body installed in a main body so that the sub-body can be opened/closed at a predetermined angle on the main body.

These terminals have various additional functions besides a basic function of audio communication with other terminals. Examples of some additional functions include transmission of e-mail or characters, download of information data, Internet game playing, text transmission and so on. Further, the field of visual communications is becoming more popular among terminal users as the CDMA 1×EVDO technique is introduced.

Therefore, in order to carry out the above functions, the terminals are further provided with various function keys, a miniature camera and so on. For example, the terminals are provided with additional navigation keys (so-called seesaw keys) capable of operating in vertical and lateral directions in addition to a number of alpha-numeric keys for the purpose of using the Internet by adopting the visual communication or a wide LCD.

However, as the navigation keys are necessarily installed in the terminals in addition to the alpha-numeric keys, installation thereof creates problems which run counter to the recent trend which gradually downsizes and reduces the weights of the terminals to meet the desire of the users.

### SUMMARY OF THE INVENTION

Accordingly, the present invention has been made to solve the foregoing problems and it is an object of the present invention to provide a keypad assembly in a portable radio terminal which allows a terminal to execute its various functions while minimizing the size thereof.

It is another object of the invention to provide a keypad assembly in a portable radio terminal having navigation keys which can also operate as alpha-numeric keys.

According to an aspect of the invention to obtain the above objects, provided is a keypad assembly in a portable radio terminal which has a main body and a sub-body pivotally installed in the main body and the keypad assembly installed in the main body or the sub-body for functioning as data input means, the keypad assembly comprising: a number of alpha-numeric keys arranged on the main body or the sub-body; navigation keys installed among the alpha-numeric keys for executing both alpha-numeric and navigation functions; and a function key installed separate from the alpha-numeric and navigation keys for executing switching between the alpha-numeric function and the navigation function of the navigation keys.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a portable radio terminal according to a preferred embodiment of the invention;

FIG. 2 is a perspective view illustrating the back side of the portable radio terminal according to the preferred embodiment of the invention;

FIG. 3 is a perspective view illustrating the opened posture of the portable radio terminal according to the preferred embodiment of the invention; and

FIG. 4 is a flow chart illustrating a method of switching a key mode of the portable radio terminal according to the preferred embodiment of the invention.

### DETAILED DESCRIPTION OF THE PREFERRED EMBODIMENT

Although the following detailed description will illustrate a folder-type portable radio terminal according to a preferred embodiment of the invention, it is obvious that the invention can be applied to various types of terminals such as a flip-type terminal, a flip-up terminal, a typical bar-type terminal and a Personal Digital Assistant (PDA).

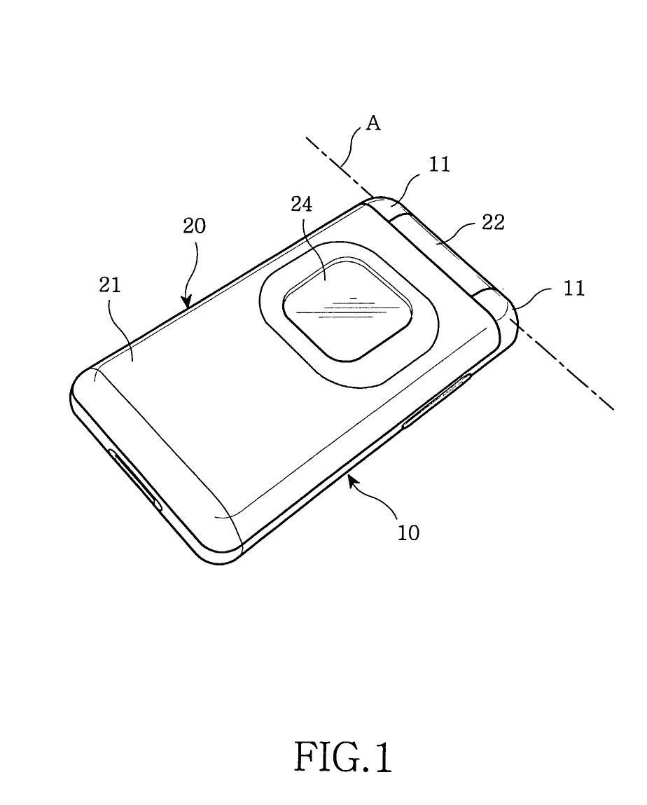

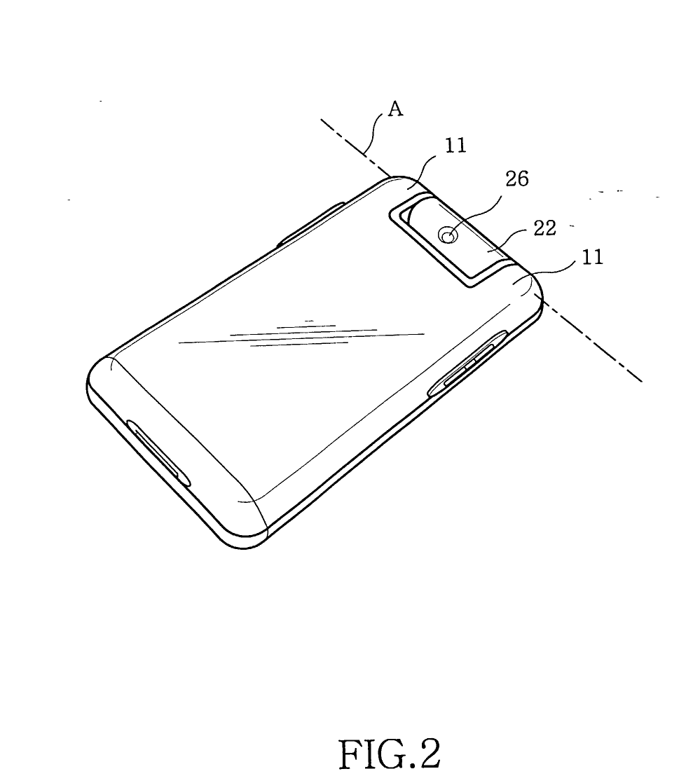

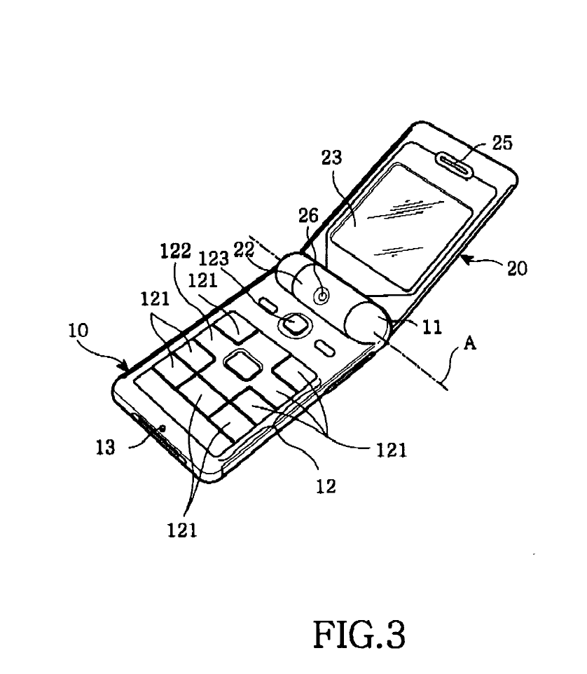

FIG. 1 is a perspective view illustrating a portable radio terminal according to a preferred embodiment of the invention, FIG. 2 is a perspective view illustrating the back side of the portable radio terminal according to the preferred embodiment of the invention, and FIG. 3 is a perspective view illustrating the opened posture of the portable radio terminal according to the preferred embodiment of the invention.

As shown in FIGS. 1 to 3, a portable radio terminal of the invention has a main body 10 and a sub-body or folder 20 pivotally installed in the body main 10. The folder 20 can be opened by hingeably coupling the folder 20 to the main body 10. In the invention, both side hinge arms 11 are installed or formed as part of the main body 10, and a central hinge arm 22 is installed on the folder 20 so that the central hinge arm 22 and the side hinge arms 11 can be hingeably coupled by settling the central hinge arm 22 between the side hinge arms 11 of the main body 10, thereby allowing the folder 20 and the central hinge arm 22 to rotate together in respect to a rotation axis A.

Further, in this embodiment, the central hinge arm 22 is provided with a camera lens assembly 26 capable of photographing a subject or executing visual communication. Therefore, as shown in FIG. 2, the camera lens is externally exposed even if the folder 20 is folded on the main body 10 so as to allow the camera to operate even when the folder 20 is in its closed position. At this time, a slave display device 24 installed in a cover face 21 can be used to observe the subject focused by the camera lens assembly 26.

As shown in FIG. 3, illustrating the construction of the terminal according to the embodiment of the invention, a keypad assembly 12 is installed in the main body 10. Keypad assembly 12 functions as data input means and has a number of keys. Under the keypad assembly 12 is installed a microphone device 13 for receiving audio signals from the user. Further, the folder 20 is provided with a main display device 23 for displaying data input via the keypad assembly 12 and a speaker device 25 for outputting audio signals received by the terminal and located above the main display device 23.

The keypad assembly 12 is comprised of a number of alpha-numeric keys 121 and various keys above the alpha-numeric keys 121. In a preferred embodiment of the invention, the alpha-numeric keys 121 are arranged in the form of a 3×4 array. Among the alpha-numeric keys 121, are installed certain navigation keys 122. The navigation keys 122 can be installed corresponding to the arrangement of the alpha-numeric keys 121, and preferably adopt seesaw a key capable of operating in four directions. Further, above the alpha-numeric keys 121, is installed a function key 123 separate from the alpha-numeric and navigation keys so as to execute function switching between alpha-numeric and navigation functions.

On a standard telephone keypad, numbers and letters appear on the keys and are used to enter a telephone number. Typically, the numbers are a sequence of “1” through “10” (10 being represented by “0”) with an “*” key and a “#” key. The standard 3×4 key array of these keys is well known in the art. According to a preferred embodiment of the present invention, the “2”, “4”, “6” and “8” keys would appear on the navigation keys 122, and depending on whether the terminal is in the alpha-numeric mode or the navigation mode, the keys will operate as alpha-numeric keys or navigation keys, respectively. Note that in addition to the number input capabilities of the telephone keys 121, the navigation keys 122 would also double as the corresponding letter keys on a standard telephone keypad.

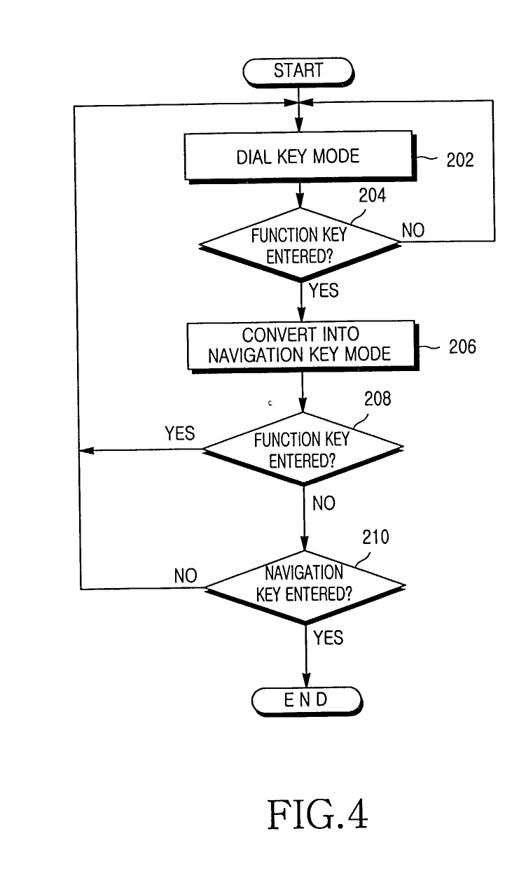

Hereinafter, the switching operation between key modes in the above constructed portable radio terminal will be described with reference to FIG. 4.

Preferably, the keypad assembly of the portable radio terminal is set in a alpha-numeric key mode as the basic mode in step 202. If the function key 123 is pressed in step 204, which generates a switch mode command, the portable radio terminal is switched into the navigation key mode in step 206. If the portable radio terminal is switched into the navigation key mode, a user can use the navigation keys 122 to navigate rather than perform the alpha-numeric functions. If the function key 123 is entered again in step 208, the portable ratio terminal is switched into the initial alpha-numeric key mode again.

In the meantime, if the navigation key is not entered for a predetermined time period in step 210 after switching into the navigation key mode, the portable radio terminal is switched into the alpha-numeric key mode.

As above, the user can normally use the navigation keys 122 as the alpha-numeric keys, and use the alpha-numeric keys as converted into the desired navigation keys, if necessary, by entering the function key 123.

According to the invention, the navigation keys can double as the alpha-numeric keys so as to satisfy the increasing desire of consumers for downsizing the terminal while incorporating sophisticated functions such as PDA, camera and TV. In particular, since the navigation keys have a high availability, utilizing the alpha-numeric keys has an effect of increasing the usability for the consumers.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A portable radio terminal having a keypad assembly, the keypad assembly comprising:
a plurality of alpha-numeric keys for entering alpha-numeric data;
at least one navigation key installed among the plurality of alpha-numeric keys for entering navigational data in a navigation mode and alpha-numeric data in an alpha-numeric mode, said alpha-numeric data of the at least one navigation key is in addition to the alpha-numeric data enterable by the plurality of alpha-numeric keys;and
a function key for switching between the navigation mode and the alpha-numeric mode of the at least one navigation key.

2. The keypad assembly according to claim 1, wherein the at least one navigation key is a seesaw key capable of operating in four directions, wherein each of the four directions operates a separate navigation function and a separate alpha-numeric function.

3. The keypad assembly of claim 1, wherein the plurality of alpha-numeric keys and the at least one navigation key are arranged in a standard 3×4 telephone key matrix.
